(19) United States
(12) Patent Application Publication
(10) Pub. No.: US 2011/0086217 A1
(43) Pub. Date: Apr. 14, 2011

(54) SPRAY POLYURETHANE FOAM FOR NON-COVERED AND NON-COATED USE IN STRUCTURAL APPLICATIONS

(76) Inventors: Steven P. Crain, Midland, MI (US); Joann E. Surma, Midland, MI (US)

(21) Appl. No.: 12/887,602

(22) Filed: Sep. 22, 2010

Related U.S. Application Data
(60) Provisional application No. 61/250,673, filed on Oct. 12, 2009.

(51) Int. Cl. B32B 27/18; B05D 5/00; B32B 3/26; B32B 27/40

(52) U.S. Cl. 428/305.5; 427/244

(57) ABSTRACT

A structure can be prepared comprising a substrate, such as a wall, ceiling or floor, and, as a non-covered layer applied thereon, a spray polyurethane foam. The foam formulation used to prepare the spray polyurethane foam includes a polyol component having a functionality equal to or greater than 2.1, an isocyanate component having a functionality equal to or greater than 2.7, an aromatic bromine-containing flame retardant agent, a phosphorus-containing flame retardant agent and a blowing agent. The structure containing the spray polyurethane foam is capable of passing the International Code Council Evaluation Service's Acceptance Criteria 377 Appendix X test without covering the spray polyurethane foam or coating the spray polyurethane foam with an intumescing coating, and therefore can be particularly useful in attics, crawl spaces, and other areas in which the foam would be exposed.

### CROSS REFERENCE STATEMENT

This application claims the benefit of U.S. Provisional Application No. 61/250,673, filed Oct. 12, 2009, the entire content of which is incorporated herein by reference.

### BACKGROUND

1. Field of the Invention

This invention relates to structures containing polyurethane spray foams and methods of applying polyurethane spray foam to structures. In particular, it relates to polyurethane spray foams that are useful in structure open spaces, such as attics and crawl spaces, where the foam is not covered.

2. Background of the Art

Spray polyurethane foams have long been used for insulation purposes. In that application the foams can be rapidly applied and are intended to provide effective air barriers in structures of all types. However, it is often required that, in order to meet either civil or military code requirements, an ignition barrier also be included in the structure to protect the spray polyurethane foam from ignition sources, such as pilot lights or sparks from maintenance related activities. This can pose a problem, however, when the “room” in question is an attic or crawl space in which a spray polyurethane foam will not be enclosed by both an interior and exterior wall, but will, rather, be left exposed to the interior of the room. Coatings and coverings (barriers) that are capable of enabling a spray polyurethane foam to meet code requirements can be employed, but represent additional application time and expense, and might still not perform as desired. Thus, it would be desirable for the spray polyurethane foam itself to be capable of meeting code requirements without addition of either a code-prescribed ignition barrier, covering or even coating of any kind.

Testing to determine certain properties of a given spray polyurethane foam can be used to certify foam as meeting code requirements, and also to obtain some idea of possible outcomes if the foam were to be exposed, without an ignition barrier or coating of any kind, to actual fire conditions in a structure. One measurement that can be taken is of the spray polyurethane foam's flame spread index, via a test defined by ASTM E 84. The flame spread index is a number or classification indicating how far a flame will propagate away from the source of ignition across the surface of the foam within a specified time period. A low flame spread index in a material can, theoretically, allow for increased opportunity for detection and suppression of the flame under actual fire conditions, whether the fire is on a wall, floor, or ceiling. It can also indicate that the spread of such a fire, either through the insulation into adjacent spaces or along the face of the insulation into adjoining spaces through openings such as doorways, can be reduced in comparison with foams having a higher flame spread index. A low flame index can be particularly significant when evaluating a spray polyurethane foam that is to be used non-covered and non-coated in an attic or crawl space, where the non-covered and non-coated foam is literally the only protection between the structural framing or habitable space and a flame ignited in, or spread to, the interior of the attic or crawl space. It can also arise in a situation wherein a foam is used on the exterior of a temporary structure, such as a tent, where a plurality of structures exist in close proximity and where it is desirable to protect other structures from a fire which starts in the interior of the first structure.

Recently new standards relating to flame spread have been promulgated by the International Code Council Evaluation Service (ICC-ES). ICC-ES's Acceptance Criteria 377 Appendix X requires that spray polyurethane foam pass a time test for flame spread in a room corner test configuration. The time periods specified in the test were determined previously based upon consideration of a different test, the ICC-ES of National Fire Protection Association 286 (NFPA 286) tests, which measure flame spread in a room corner configuration wherein a spray polyurethane foam is covered with a quarter-inch thick plywood. Acceptance Criteria 377 Appendix X now requires that the average time from ignition to four specific events must be equal to or greater than a total of four minutes and 18 seconds. It is desirable to pass the Criteria 377 Appendix X test with a foam that is exposed to flames rather than covered with an ignition barrier, such as plywood, as in the ICC-ES NFPA 286 test. It is even more desirable to pass the Acceptance Criteria 377 Appendix X test with a foam that is exposed to the flames without being covered or coated with a flame retarding material of any kind.

In view of this, researchers continue to seek means of obtaining spray polyurethane foams which, when applied on a structure and maintained in an non-covered and non-coated state, can or are likely to slow fire progression to that structure and/or along the non-covered surface of the foam. Ability to perform well in standardized tests, such as ASTM E 84 and Acceptance Criteria 377 Appendix X, can be useful means of identifying such foams.

### SUMMARY OF THE INVENTION

In one embodiment, the invention provides a structure comprising (1) a substrate and (2) a spray polyurethane foam; the foam being prepared from a spray polyurethane foam formulation including (a) a polyol component having a functionality equal to or greater than 2.1, (b) an isocyanate component having a functionality equal to or greater than 2.7, (c) an aromatic bromine-containing flame retardant agent in an amount of at least 2 percent by weight, based on the weight of the polyol component, (d) a phosphorus-containing flame retardant agent in an amount of at least 2 percent by weight, based on the weight of the polyol component, and (e) a blowing agent; wherein the spray polyurethane foam prepared therefrom is maintained on the substrate as an non-covered layer that is free of an intumescing coating, the spray polyurethane foam being capable of passing the International Code Council Evaluation Service's Acceptance Criteria 377 Appendix X test as a non-covered and non-coated foam layer on the substrate wherein the foam layer is directly exposed to a flame.

In another embodiment the invention provides a method of preparing a structure including a substrate and a spray polyurethane foam, the method comprising (1) applying to the substrate a spray polyurethane foam formulation comprising: (a) a polyol component having a functionality equal to or greater than 2.1, (b) an isocyanate component having a functionality equal to or greater than 2.7, (c) an aromatic bromine-containing flame retardant agent in an amount of at least 2 percent by weight, based on the weight of the polyol component, (d) a phosphorus-containing flame retardant agent in an amount of at least 2 percent by weight, based on the weight of the polyol component, and (e) a blowing agent; (2) allowing the spray polyurethane foam formulation to expand into the spray polyurethane foam; and (3) maintaining the spray polyurethane foam non-covered and free of intumescing coatings; the spray polyurethane foam being capable of passing the International Code Council Evaluation Service's Acceptance Criteria 377 Appendix X test as a non-covered and non-coated foam layer on the substrate wherein the foam layer is directly exposed to a flame.

### DETAILED DESCRIPTION OF THE EMBODIMENTS

The formulation of the invention can be used to prepare an inventive spray polyurethane foam that can exhibit markedly low flame spread, as determined by various industry tests such as ASTM E 84 Flame Spread Index and the International Code Council Evaluation Service's Acceptance Criteria (AC) 377 Appendix X (Room Corner Comparative Flame Spread Analysis). It can further offer a desirably intumescent and/or stabilized char capability such that the foam underneath the charred portion is protected from further ignition. These capabilities make the foam suitable for a wide variety of applications, but particularly for attics and crawl spaces in residential and commercial structures or wherever it can be difficult to apply an ignition barrier, intumescent coating or thermal barrier, and therefore wherever it is code-allowed and/or desired that the foam remain non-covered after installation.

As used herein, the terms “structure” and “structures” refer to any man-made entity having a surface upon which it is deemed desirable to apply spray polyurethane foam. That surface is referred to herein as a “substrate.” The terms “structure” or “structures” therefore include, without limitation, residential and commercial buildings; temporary housing means such as tents, trailers, and Quonset huts; housings built for equipment such as pumps, filtration systems, and communications circuitry; tanks, pipes, conduits and tank trucks designed for storage or transport of liquid or gaseous materials; and the like.

The term “coating” refers to a material applied over a foam and that directly contacts and adheres to the foam. The term “non-coated” means that after the foam is applied to the structure substrate, the foam remains exposed without a coating having been applied to the foam. The term “covering” refers to a material positioned over a foam and that does or does not contact the foam but remains unattached to the foam. The term “non-covered” means that, after the foam is applied to the structure substrate, the foam is not then wrapped, faced, covered or enclosed with covering, but rather the portion of the foam that faces away from the substrate where it is applied remains exposed to the surrounding environment.

As is well known to those skilled in the art of preparing rigid polyurethane spray foams, a variety of conventional rigid polyurethane foam formulations can be selected, with alterations as needed to accommodate application via conventional spray foam equipment. Such foams are typically prepared from a combination of an isocyanate component, an isocyanate-reactive component, catalysts, and a blowing agent suitable to foam the isocyanate component and isocyanate-reactive component while they are reacting to form the polyurethane polymer.

The spray polyurethane foam formulation includes at least four necessary components. These are a polyol component having a functionality of at least 2.1; an isocyanate component having a functionality of at least 2.7; a bromine-containing flame retardant agent in an amount greater than 2 percent by weight, based on the weight of the polyol component; and a phosphorus-containing flame retardant agent in an amount of at least 2 percent by weight, on the same basis.

### The Polyol Component

The first component is the polyol component. In specific embodiments, the polyol component has a functionality of at least 2.1, while in other non-limiting embodiments it can have a higher functionality, of at least 2.2 or greater. The functionality refers to the total functionality of all isocyanate-reactive species included in the polyol component, i.e., the overall average functionality of the component as a whole. Therefore, the polyol component can include individual constituent polyols having both higher and lower functionalities, along with additives which can also have isocyanate-reactive functionality. The polyol blend functionality is calculated by summing up the isocyanate reactive equivalents of all components in the polyol formulation and dividing by the sum of the ratio of the individual isocyanate reactive equivalents and individual isocyanate reactive functionality.

$${f}_{blend} = \frac{\sum {EQ}_{individual}}{\sum {EQ}_{individual} / {f}_{individual}}$$

$$where$$

$$f ≡ functionality$$

$$and$$

$$EQ ≡ equivalents$$

The polyol component can be alternatively referred to as the isocyanate-reactive component. This component includes primarily polymers containing groups that react with the isocyanate component to form a rigid polyurethane foam but also includes non-reactive additives. Frequently the reactive groups are hydroxyl groups, but other isocyanate-reactive groups, including but not limited to amine, carboxylic acid and alkylthiol groups, can optionally be selected. They are generally formed by base-catalyzed addition of propylene oxide (PO) and/or ethylene oxide (EO) onto a hydroxyl- or amine-terminated initiator, or by polyesterification of a diacid, such as adipic acid, with glycols, such as ethylene glycol or dipropylene glycol. In some cases natural oil polyols, such as canola, castor, or grapeseed, can be employed. Polyols extended with PO or EO are polyether polyols. Polyols formed by polyesterification are polyester polyols. The choice of initiator, extender, and molecular weight of the polyol greatly affect the physical state and the physical properties of the polyurethane polymer. In general, spray foam formulations are very fast-reacting formulations, and the rigid spray polyurethane foams of the invention are, in certain non-limiting embodiments, polyols having high functionality initiators as the polyol component or constituents thereof. Such high functionality initiators can include, for example, sucrose (f=8), sorbitol (f=6), toluenediamine (f=4), Mannich bases (f=4), and Novolac-initiated polyols. Polyester polyols, which include low molecular weight aromatic types that are manufactured by, for example, transesterification (glycolysis) of recycled polyethyleneterephthalate (PET) or dimethylterephthalate (DMT) distillation bottoms with glycols such as diethylene glycol, can also be useful in preparing polyurethane spray foams.

The polyol or polyols that make up the polyol component can, in certain desirable embodiments, have a viscosity ranging from 100 centipoise (cP) to 100,000 cP, and in other embodiments, from 200 cP to 100,000 cP.

### The Isocyanate Component

Selection of the isocyanate component can be made from a variety of isocyanate-group containing materials. However, in one embodiment of the invention an isocyanate component having an average functionality equal to or greater than 2.7 and containing a polymeric methylene diphenyl diisocyanate (PMDI) can be selected. In certain particular embodiments this functionality can be greater than 3.0 and in still other embodiments the average functionality can be greater than 3.3. In some non-limiting embodiments the isocyanate component has an equivalent weight from 125 to 300, and in other non-limiting embodiments, from 130 to 175.

In any embodiment of the present invention the isocyanate can comprise PMDI. PMDI is particularly desirable, in certain embodiments, as the isocyanate component because it is commercially available as a product having an average functionality greater than 3.0. It is therefore useful in increasing the overall functionality of the isocyanate component, such that the minimum average functionality requirement (equal to or greater than 2.7) can be met. In certain particular embodiments the isocyanate component can include polymeric content ranging from at least 60 percent by weight, the remainder being monomeric content. It will be recognized that many commercially available PMDIs include polymeric-to-monomeric constituent ratios within these ranges. In some embodiments the PMDI included in the present invention can have an even higher polymeric content, from at least 75 percent by weight. In general this PMDI can be present neat, in a mixture, as a part of a prepolymer, or in two or all of these forms.

Where the PMDI is less than 100 percent by weight of the isocyanate component as a whole, additional isocyanate-group containing materials can be included. Such can be selected from a wide variety of polyisocyanates, including but not limited to those that are well known to those skilled in the art. For example, organic polyisocyanates, modified polyisocyanates, isocyanate-based prepolymers, and mixtures thereof can be employed. These can further include aliphatic and cycloaliphatic isocyanates, and in particular aromatic, and more particularly multifunctional aromatic isocyanates. Some of these can also be useful in increasing the overall functionality of the isocyanate component to meet the minimum functionality.

Other polyisocyanates that can be useful in the present invention include 2,4- and 2,6-toluenediisocyanate and the corresponding isomeric mixtures; 4,4′-, 2,4′- and 2,2′-diphenyl-methanediisocyanate and the corresponding isomeric mixtures; and toluene diisocyanates. Also useful for preparing the rigid polyurethanes of the present invention are aliphatic and cycloaliphatic isocyanate compounds such as 1,6-hexa-methylene diisocyanate; 1-isocyanato-3,5,5-trimethyl-1,3-isocyanatomethylcyclohexane; and 2,4- and 2,6-hexahydrotoluene diisocyanate, as well as the corresponding isomeric mixtures; and 4,4′-, 2,2′- and 2,4′-dicyclohexylmethanediisocyanate and the corresponding isomeric mixtures. Also useful is 1,3-tetramethylene xylene diisocyanate.

Also advantageously used for the isocyanate are the so-called modified multifunctional isocyanates, that is, products which are obtained through chemical reactions of the above diisocyanates and/or polyisocyanates. Exemplary are polyisocyanates containing esters, ureas, biurets, allophanates and preferably carbodiimides and/or uretonomines; isocyanurate and/or urethane group containing diisocyanates or polyisocyanates. Liquid polyisocyanates containing carbodiimide groups, uretonomine groups and/or isocyanurate rings, having isocyanate groups (NCO) contents of from 20 to 40 weight percent, more preferably from 20 to 35 weight percent, can also be used. These include, for example, polyisocyanates based on 4,4′-, 2,4′- and/or 2,2′-diphenylmethane diisocyanate and the corresponding isomeric mixtures; 2,4- and/or 2,6-toluenediisocyanate and the corresponding isomeric mixtures; mixtures of diphenylmethane diisocyanates; and mixtures of toluenediisocyanates and/or diphenylmethane diisocyanates. As already noted hereinabove, PMDI can be included with any of the above, but since the invention can instead include one or more of the alternative bond enhancing agents, PMDI can be omitted completely from the isocyanate component and the benefits of the invention obtained via such alternative route(s), i.e., the triethanolamine and/or 1-methyl-imidazole.

The viscosity of the isocyanate component is, in some embodiments, from 25 to 5,000 centipoise (cP) at 25° C. (0.025 to 5 Pascal*seconds (Pa*s)), but values from 100 to 1,000 cP at 25° C. (0.1 to 1 Pa*s) might be preferred for ease of processing.

### The Aromatic Brominated Flame Retardant Agent

While aromatic brominated flame retardant agents are generally known in the art, the present invention uses a combination of flame retardant agents that preferably acts synergistically with phosphorous-containing flame retardant agent. The first required flame retardant is an aromatic brominated flame retardant agent, which can be either an additive or a reactant. Thus, suitable compounds for inclusion herein can be selected from among materials such as decabromodiphenyl ether (decaBDE) and other polybrominated diphenyl ethers (PBDEs), including, for example, pentabromodiphenyl ether (pentaBDE), octabromodiphenyl ether (octaBDE), tetrabromobisphenol A (TBBPA or TBBP-A), tetrabromophthalate (TBP), bromopropane, and combinations thereof. A few particular examples can include brominated aromatic ester polyols such as PHT4-Diol, which is a tetrabromophthalate (TBP) available from Chemtura, and RB79, available from Albemarle Corporation.

### The Phosphorus-Containing Flame Retardant Agent

The phosphorus-containing flame retardant agent, like the aromatic brominated flame retardant agent, can be either an additive or a reactant compound. Suitable compounds for inclusion can include triethyl phosphate (TEP), tris(2-chloro-isopropyl phosphate) (TCPP), tris(2,3-dibromopropyl) phosphate (TRIS), bis(2,3-dibromopropyl) phosphate, triethylphosphate (TEP), tris(2-chloroethyl) phosphate, tris(2-chloropropyl)phosphate, tris(1,3-dichloropropyl)phosphate, diammonium phosphate, and combinations thereof. In certain preferred embodiments the phosphorus-containing flame retardant agent is triethyl phosphate (TEP) or tris(2-chloroisopropyl phosphate) (TCPP), and in a particularly preferred embodiment it is triethyl phosphate (TEP).

In a particular non-limiting embodiment, a combination of the reactant aromatic bromine-containing flame retardant agent tetrabromophthalate (TBP) and the additive phosphorus-containing flame retardant agent triethyl phosphate (TEP) can be employed.

### The Blowing Agent

In preparing the spray polyurethane foams of the invention, a blowing agent is generally incorporated in order to provide the cellular structure. While the blowing agent can be, in many spray foam formulations, included in the polyol component, prior to combination with the isocyanate component, it can also alternatively be a separate component in itself, combining simultaneously with the isocyanate component and polyol component in, for example, conventional spray equipment capable of feeding three streams at once. Blowing agent selections can include water, hydrocarbons, chlorinated hydrocarbons, fluorinated hydrocarbons, chlorofluorocarbons, and combinations thereof. Of particular use can be HFC-245fa. Other examples can include HCFC-141b, HCFC-22, HFC-134a, n-pentane, isopentane, cyclopentane, trans-1,2-dichloroethylene, HCFC-124, HFC-365mfc, and combinations thereof. Some halocarbon blowing agents, in particular, can be effective in reducing viscosity to a desirable level to optimize sprayability.

### Catalysts

It is typical in polyurethane spray foam formulation to employ one or more catalysts, to initiate and/or facilitate the polymerization (gel) and/or blowing of the foam. For this purpose, a variety of catalysts can be selected, and amine catalysts are particularly useful. Such can typically include the N-alkylmorpholines, N-alkylalkanolamines, N,N-dialkylcyclohexylamines, alkylamines where the alkyl groups are methyl, ethyl, propyl, butyl and isomeric forms thereof, and heterocyclic amines. Typical but non-limiting specific examples thereof are triethylenediamine, tetramethylethylenediamine, bis(2-dimethylaminoethyl)ether, triethanolamine, triethylamine, tripropylamine, tributylamine, triamylamine, pyridine, quinoline, dimethylpiperazine, piperazine, N,N-dimethylcyclohexylamine, N-ethylmorpholine, 2-methylpropanediamine, methyltriethylenediamine, 2,4,6-tri-dimethylaminomethyl)phenol, N,N′,N″-tris(dimethylaminopropyl)-sym-hexahydrotriazine, 1-methylimidazole, and combinations thereof. A preferred group of tertiary amines comprises bis(2-dimethyl-aminoethyl)ether, dimethylcyclohexylamine, N,N-dimethyl-ethanolamine, triethylenediamine, triethylamine, 2,4,6-tri(dimethylaminomethyl)phenol, N,N′,N-ethylmorpholine, and combinations thereof.

Non-amine catalyst can also be used in the present invention. Typical of such catalysts are organometallic compounds of bismuth, lead, tin, titanium, iron, antimony, uranium, cadmium, cobalt, thorium, aluminum, mercury, zinc, nickel, cerium, molybdenum, vanadium, copper, manganese, zirconium, and combinations thereof. Included among these are bismuth nitrate, lead 2-ethylhexoate, lead benzoate, lead naphthenate, ferric chloride, antimony trichloride, and antimony glycolate. A preferred group of organo-tin catalysts includes the stannous salts of carboxylic acids, such as stannous acetate, stannous octoate, stannous 2-ethylhexoate, and stannous laurate, as well as the dialkyl tin salts of carboxylic acids, such as dibutyl tin diacetate, dibutyl tin dilaurate, dibutyl tin dimaleate, dioctyl tin diacetate, and combinations thereof.

One or more trimerization catalysts can optionally also be used with the present invention. The trimerization catalyst employed can be any known to those skilled in the art which will catalyze the trimerization of an organic isocyanate compound to form the isocyanurate moiety. For typical isocyanate trimerization catalysts, see The Journal of Cellular Plastics, November/December 1975, page 329: and U.S. Pat. Nos. 3,745,133; 3,896,052; 3,899,443; 3,903,018; 3,954,684; and 4,101,465; the disclosures of which are incorporated herein in their entireties by reference. Typical trimerization catalysts include the glycine salts and tertiary amine trimerization catalysts, as well as the alkali metal carboxylic acid salts and combinations thereof. Preferred species within the classes are sodium N-2-hydroxy-5-nonylphenyl) methyl-N-methylglycinate, N,N-dimethylcyclohexylamine, and mixtures thereof. Also included in this list are the epoxides disclosed in U.S. Pat. No. 3,745,133, the disclosure of which is incorporated herein in its entirety by reference.

### Optional Additional Constituents

Dispersing agents, cell stabilizers, surfactants, colorants, fillers, and materials serving two or more of these functions can also be incorporated into the formulations. Surfactants can include organic and silicone-based additives. Exemplary materials can be commercially available under the designations SF-1109, L-520, L-521 and DC-193, which are, generally, polysiloxane polyoxyalkylene block copolymers. Further information can be found in U.S. Pat. Nos. 2,834,748; 2,917,480; and 2,846,458; the disclosures of which are incorporated herein in their entireties by reference. Also included are organic surfactants containing polyoxyethylene-polyoxybutylene block copolymers as described in, for example, U.S. Pat. No. 5,600,019, the disclosure of which is incorporated herein in its entirety by reference. Fillers can include both natural and synthetic minerals, clays, and similar particulates.

### Proportions

It is generally desirable that the isocyanate component and the polyol component be admixed at any suitable volume or weight ratio as desired for the particular foam composition, formulation method or equipment. In certain embodiments, however, it is desirable that the isocyanate index, which represents the ratio of the isocyanate component to the polyol component, be greater than 100, i.e., that there is more of the isocyanate component than of the polyol component. In certain particular embodiments, such index can be 110 or higher, i.e., the ratio of isocyanate component to polyol component is 1.10:1 or higher. In other particular embodiments, the index can be 125 or higher.

The isocyanate index is calculated by the following equation (the term “hydroxyls” in the equation is used to indicate any isocyanate-reactive group):

$$Isocyanate Index = \frac{\sum {EQ}_{isocyanate}}{\sum {EQ}_{hydroxyls}}$$

$$where$$

$$EQ ≡ equivalents$$

The aromatic bromine-containing flame retardant agents are used in the present invention in an amount that is at least 2 percent by weight, based on the weight of the polyol component including the blowing agent. In certain preferred embodiments the aromatic bromine-containing agent can be used in an amount from 2 percent to 20 percent by weight on the same basis, and in other preferred embodiments it can be from 2 percent to 10 percent by weight on the same basis.

The phosphorus-containing flame retardant agents are used in an amount of at least 2 percent by weight, based on the weight of the polyol component including the blowing agent. In certain preferred embodiments this agent can be from 5 percent to 10 percent by weight on the same basis, and in other preferred embodiments it can be from 7 percent to 10 percent by weight on the same basis.

In the polyurethane foam formulations including water as the blowing agent, the water is desirably present in an amount of from 0.5 to 40 parts by weight, based on 100 parts of polyol component. In more particular and non-limiting embodiments, water can be used in an amount of from 1 to 35 parts by weight, on the same basis, and in still more preferred but non-limiting embodiments, water can be employed in an amount of from 2 to 30 parts by weight, again, on the same basis. Other blowing agents, such as HFC-245fa, are used, in certain non-limiting embodiments, in an amount from 5 to 20 by weight, based on the polyol component.

Catalysts, such as NIAX™ A-1, POLYCAT™ 9 and/or POLYCAT™ 77, can be included in amounts from 1 to 15 parts by weight, on the same basis. NIAX™ A-1 is a trademark of General Electric corporation and POLYCAT is a trademark of Air Products and Chemicals Inc. Additional catalysts, such as TOYOCAT™ DM 70 or other gelling catalysts, can be included in amounts ranging from 0 to 5 parts by weight, on the same basis. (TOYOCAT™ is a trademark of Tosoh Corporation).

Surfactants, such as DABCO™ DC-193, can be included in any amount ranging from 0.25 to 6 parts by weight, on the same basis. DABCO is a trademark of Air Products and Chemicals, Inc.

### Spray Polyurethane Foam Preparation

In preparing the formulations and final foam products of the present invention any methods and means known or contemplated by those skilled in the art as useful for preparing rigid polyurethane spray foams can be employed. It is typical to include any additives and/or modifiers, such as reactant flame retardants, catalysts, surfactants, and the like with the polyol component, and then enable the isocyanate component and the polyol component to contact one another and appropriately mix within a spray gun, whereby the polymerization reaction proceeds to completion on the substrate to which the spray foam is applied, e.g., a ceiling, wall, or other substrates provided by a structure. Such substrate can include a sheathing material such as, for example, oriented strand board (OSB), plywood, gypsum sheetrock, foam board, fiberboard, cellulosic sheathing, THERMAX® insulation boards (THERMAX is a trademark of The Dow Chemical Company and is available from The Dow Chemical Company), and other structural insulated panels made of, for example, polyisocyanurate, extruded polystyrene, or expanded polystyrene. The equipment frequently used for spraying can include “double acting” positive displacement pumps which have the advantage of supplying an accurate component ratio of isocyanate component to polyol component in a continuous stream. Such systems tend to function more reliably, i.e., experience less cavitation, when each component has a viscosity of less than 2,000 cP (1 Pa*s) at 25° C. Another parameter that is considered by those skilled in the art is that the commercially adopted standard design for such equipment usually requires a 1:1 volume ratio of isocyanate component to polyol component, and thus adjustment may need to be made, usually by the polyol formulator, to ensure that the index, i.e., ratio of terminal isocyanate groups to terminal isocyanate-reactive groups, is at least 100 and, in some embodiments, up to 125 or even higher.

### The Spray Polyurethane Foam

Final foam density can, in certain non-limiting embodiments, range from 6.4 to 160 kilograms per cubic meter (kg/m³) (0.4 to 10 pounds per cubic foot (pcf)); in other non-limiting embodiments, from 12.8 to 80 kg/m³ (0.8 to about 5 pcf); and in still other non-limiting embodiments, from 24 to 64 kg/m³ (1.5 to 4 pcf). In particularly preferred embodiments it can be about 40 kg/m³ (2.5 pcf), as tested according to the American Society for Testing Materials (ASTM) D 1622-03. Such density ranges may be particularly desirable in preparing a structure providing both desirable levels of insulation and good flammability performance, while the higher densities within the given range (greater than 16 kg/m³ (1 pcf)) can be more effective where it is desirable to augment structure strength as well. The spray foams of the invention can have a cell structure that is a mixture of open and closed. The final foam cell structure can, in certain non-limiting embodiments, range from 50 to 100 percent closed; in other non-limiting embodiments, from 80 to 100 percent closed; and in still other non-limiting embodiments, from 90 to 100 percent closed. In particularly preferred embodiments it can be more than 95 percent closed, as tested according to ASTM D 6226-05.

Significantly, the spray foams used in the invention can achieve excellent and desirable flammability ratings when tested according to the ASTM E 84 Test. This means that, in certain embodiments, the foams exhibit a Flame Spread Index that is equal to 75, and preferably less than 50. In particular embodiments the foams can achieve a Class A rating, which means that their Flame Spread Index is less than or equal to 25 and they also have a Smoke Developed Index which is less than or equal to 450. They also achieve a “pass” rating when tested according to AC 377 Appendix X (Room Corner Comparative Flame Spread Analysis), which means that during testing four events, as shown in the Examples herein below, require a minimum average time of at least four minutes and 18 seconds. Because this is achieved without any covering or coating, the foams can be particularly suitable for application on substrates, such as walls, ceilings, floors, and the like, in attics, crawl spaces and other locations, in structures where the foam will not be covered. The foams can also be suited for application on substrates, such as walls, where it is applied both to between-stud cavities and to stud faces, thus forming a layer which, because it is continuous between cavities, can present a more difficult challenge with respect to flame spread issues.

Surprisingly, structures assembled for AC 377 Appendix X testing pass the test with non-covered foams, derived from the formulation described herein, exposed to the flames in the test. Even more surprising, structures assembled for AC 377 Appendix X testing pass the test non-covered and while free of intumescing coatings (non-coated with intumescent coatings). Structures containing the foam derived from the above formulation can pass the AC 377 Appendix X testing even if they are free of any covering (non-covered) and free of any coating (non-coated) and exposed to flames during the testing.

In one desirable embodiment, the process of the present invention includes applying a spray polyurethane foam formulation as described herein onto a substrate of a structure and allowing it to produce a rigid foam and then further coating the rigid foam with a non-intumescing ultraviolet barrier coating to produce a structure having an exposed polyurethane foam that is non-covered and free of intumescent coatings but that contains an ultraviolet barrier coating.

### EXAMPLES

Materials used include the following:

### Polyol Component:

“Aromatic bromine-containing flame retardant agent” is PHT4-DIOL, a tetrabromophthalate product available from The Dow Chemical Company.
“Phosphorus-containing flame retardant agent” is triethyl phosphate (TEP).
“Additives” include surfactants, blowing and gelling catalysts, and curative agents.
“Blowing agent” is 1,1,1,3,3-pentafluoropropane (HFC-245fa).

### Isocyanate Component:

VORACOR™ CE 3019 is a polymeric isocyanate available from The Dow Chemical Company.
VORACOR™ CE 120 is a polymeric isocyanate available from The Dow Chemical Company.
ELASTOSPRAY™ 8000A is an isocyanate product available from BASF, Inc.

### Examples 1 and 2 and Comparative Examples 1 and 2

Four formulations are prepared and tested for combustion performance. Two are examples of the invention, a third (Comparative Example 1) is a comparative example that is a commercial formulation that was reverse engineered for composition, and a fourth (Comparative Example 2) is a prepared comparative example. Their formulations are shown in Table 1. The formulations are prepared by first combining all of the polyol component constituents, including the blowing agent. For the ASTM E 84 panels, the formulations are then, in turn, each fed through a Gusmer H20/35 Series Proportioning Machine and a GX 7 spray gun. The panels for the ASTM E 84 test are sprayed to a thickness of 2 inches in one pass. For the Acceptance Criteria 377 Appendix X room corner evaluation, the formulations are each fed through a Gusmer FF1600 Series

Proportioning Machine and a Fusion AP spray gun with a 02 tip. The walls and ceiling of the room corner are sprayed to form a foam layer having a thickness of 10 inches in 8 passes. In each formulation one (volume) part of isocyanate component is matched with one (volume) part of polyol component.

TABLE 1

| | | | Comparative | Comparative |
|---|---|---|---|---|
| Constituents | Example 1 | Example 2 | Example 1 | Example 2 |
| Polyol blend | Terephthalate | Terephthalate | Terephthalate | Terephthalate |
| | extended | extended | extended Aromatic | extended |
| | Aromatic | Aromatic | polyester polyol | Aromatic |
| | polyester | polyester polyol | and polyether | polyester polyol |
| | polyol and | and polyether | polyol blend | and polyether |
| | polyether | polyol blend | | polyol blend |
| | polyol blend | | | |
| Polyol component | 2.22 | 2.26 | 2.27 | 2.09 |
| average | | | | |
| functionality | | | | |
| Chain extender* | Mannich and | Mannich and | Sucrose | Mannich and |
| | phenol | phenol | | phenol |
| | formaldehyde | formaldehyde | | formaldehyde |
| | condensation | condensation | | condensation |
| | products | products | | products |
| Isocyanate | VORACOR ™ | VORACOR ™ | ELASTOSPRAY ™ | VORACOR ™ CE |
| | CE 3019 | CE 120 | 8000A | 3019 |
| Isocyanate | 2.7 | 3.0 | 2.7 | 2.7 |
| component | | | | |
| average | | | | |
| functionality | | | | |
| Bromine- | PHT4-DIOL, | PHT4-DIOL, | Not present | PHT4-DIOL, 6.0% |
| containing flame | 6.1% | 5.9% | | |
| retardant agent | | | | |
| Phosphorus- | TEP, 9.3% | TEP, 8.9% | TEP, 9.0% | TEP, 9.3% |
| containing flame | | | | |
| retardant agent | | | | |
| Blowing agent | HFC-245fa | HFC-245fa | HFC-245fa | HFC-245fa |
| Catalyst package | 5.0% | 13.2% | 2.7% | 14.3% |
| Isocyanate Index | 1.2 | 1.2 | 1.1 | 1.2 |
| Density, kg/m³ | 40 (2.5) | 40 (2.5) | 35 (2.2) | 40 (2.5) |
| (pcf) | | | | |
| Closed Cell | 95 | 95 | 95 | 95 |
| Content, % | | | | |

*used to prepare the commercial polyols having a functionality greater than two; not added separately to the spray polyurethane foam formulation

The formulations are prepared using the materials and amounts shown in Table 1, by first combining all of the polyol component constituents, including the blowing agent. Each formulation is then fed through a proportioning machine and a spray gun, to contact the polyol component, isocyanate component, and blowing agent (HFC-245fa) and apply it to the substrate wall designated for each test. The panel used for the ASTM E 84-08A test is a 0.5 inch gypsum board (G.P. Fireboard Type X), cut to approximately 22 inches wide and 8 feet long. The sheathing of the wall and ceiling used for the Acceptance Criteria (AC) 377 Appendix X test is gypsum board attached to wood studs (joists for the ceiling) at 24 inches on center. The wood studs and joists can vary in dimension, but those used in this instance are standardized as 2×8 inch (actual 1.5×7.5 inch). One (volume) part of isocyanate component is matched with one (volume) part of polyol component. The spray polyurethane foam is applied having an initial thickness as shown in Table 2. Test results for the formulations represented by Examples 1 and 2 and Comparative Examples 1 and 2 are given in Table 2.

TABLE 2

| | | | Comparative | Comparative |
|---|---|---|---|---|
| Test Information | Example 1 | Example 2 | Example 1 | Example 2 |
| Flame Spread | 17.5 | 26.3 | 134 | 69.8 |
| Index (FSI)* | | | | |
| Initial thickness | 2.00 | 2.00 | 2.00 | 2.00 |
| for FSI, inches | | | | |
| Final thickness | | | | |
| 2 ft down first | 3.50 | 4.75 | 0.00** | 2.25 |
| board | | | | |
| 6 ft down first | 2.00 | 5.00 | 1.00*** | 2.25 |
| board | | | | |
| Char thickness | | | | |
| 2 ft down first | 3.25 | 4.25 | 0.00** | 2.25 |
| board | | | | |
| 6 ft down first | 0.50 | 3.75 | 1.00*** | 2.125 |
| board | | | | |
| AC 377 | 5 minutes | — | — | — |
| Appendix X, | 25 seconds# | | | |
| average time | | | | |

*according to ASTM E 84-08A (uncorrected FSI)
**sample is completely consumed by fire
***entire sample is char
— sample cannot be tested because of inadequate sample size
#foam applied to walls and ceiling to a thickness of 10 inches in 8 passes

1. A structure comprising
(1) a substrate and
(2) a spray polyurethane foam;
the foam being prepared from a spray polyurethane foam formulation consisting essentially of:
(a) a polyol component having a functionality equal to or greater than 2.1, (b) an isocyanate component having a functionality equal to or greater than 2.7,
(c) an aromatic bromine-containing flame retardant agent in an amount of at least 2 percent by weight, based on the weight of the polyol component,
(d) a phosphorus-containing flame retardant agent in an amount of at least 2 percent by weight, based on the weight of the polyol component,
(e) a blowing agent;
(f) a catalyst; and
(g) optionally, one or more additional constituents selected from dispersing agents, cell stabilizers, surfactants, colorants, fillers and materials serving two or more of these functions;
wherein the spray polyurethane foam prepared therefrom is maintained on the substrate as a non-covered layer that is free of an intumescing coating,
the spray polyurethane foam being capable of passing the International Code Council Evaluation Service's Acceptance Criteria 377 Appendix X test as a non-covered and non-coated foam layer on the substrate wherein the foam layer is directly exposed to a flame.

2. The structure of claim 1, wherein the spray polyurethane foam is maintained on the substrate as a non-covered and non-coated foam.

3. The structure of claim 1 wherein the isocyanate component and the polyol component are present in amounts such that the formulation has an isocyanate index greater than 100.

4. The structure of claim 3 wherein the isocyanate index is equal to or greater than 125.

5. The structure of claim 1 wherein the aromatic bromine-containing flame retardant agent is selected from decabromodiphenyl ether, pentabromodiphenyl ether, octabromodiphenyl ether, tetrabromobisphenol A, tetrabromophthalate, bromopropane, and combinations thereof; and the phosphorus-containing flame retardant agent is selected from triethyl phosphate, tris(2-chloro-isopropyl phosphate), tris(2,3-dibromopropyl)phosphate, bis(2,3-dibromopropyl)phosphate, triethylphosphate, tris(2-chloroethyl)phosphate, tris(2-chloropropyl)phosphate, tris(1,3-dichloropropyl)phosphate, diammonium phosphate, and combinations thereof.

6. The structure of claim 5 wherein the aromatic bromine-containing flame retardant agent is used in an amount of at least 5 percent by weight, based on the weight of the polyol component.

7. The structure of claim 1 wherein the aromatic bromine-containing flame retardant agent is the reactant tetrabromophthalate in an amount of greater than 5 percent by weight, based on the weight of the polyol component, and the phosphorus-containing flame retardant agent is the additive triethyl phosphate.

8. The structure of claim 1 being a tent.

9. A method of preparing a structure including a substrate and a spray polyurethane foam, the method comprising
(1) applying to the substrate a spray polyurethane foam formulation consisting essentially of:
(a) a polyol component having a functionality equal to or greater than 2.1,
(b) an isocyanate component having a functionality equal to or greater than 2.7,
(c) an aromatic bromine-containing flame retardant agent in an amount of at least 2 percent by weight, based on the weight of the polyol component,
(d) a phosphorus-containing flame retardant agent in an amount of at least 2 percent by weight, based on the weight of the polyol component,
(e) a blowing agent,
(f) a catalyst, and
(g) optionally, one or more additional constituents selected from dispersing agents, cell stabilizers, surfactants, colorants, fillers and materials serving two or more of these functions;
allowing the spray polyurethane foam formulation to expand into the spray polyurethane foam; and
maintaining the spray polyurethane foam non-covered and free of intumescing coatings;
the spray polyurethane foam being capable of passing the International Code Council Evaluation Service's Acceptance Criteria 377 Appendix X test as a non-covered and non-coated foam layer on the substrate wherein the foam layer is directly exposed to a flame.

10. The method of claim 9 wherein the isocyanate component and the polyol component are present in amounts such that the formulation has an isocyanate index greater than 100.

11. The method of claim 9 wherein the aromatic bromine-containing flame retardant agent is tetrabromophthalate and the phosphorus-containing flame retardant agent is tris(2-chloro-isopropyl phosphate).

12. The method of claim 9 wherein the aromatic bromine-containing flame retardant agent is the reactant tetrabromophthalate and the phosphorus-containing flame retardant agent is the additive triethyl phosphate.

13. The method of claim 9 wherein the spray polyurethane foam obtains a flame spread index, when tested according to ASTM E 84, that is less than or equal to 25.

14. The method of claim 9 wherein the spray polyurethane foam obtains a smoke developed index, when tested according to ASTM E 84, that is less than or equal to 450.

15. The method of claim 9 wherein the substrate is a floor, wall or ceiling of an attic or crawl space, or an exterior surface of a tent, a trailer, a Quonset hut, a tank, a pipe, or a tanker truck.
